(19) United States
(12) Patent Application Publication
(10) Pub. No.: US 2007/0133098 A1
(43) Pub. Date: Jun. 14, 2007

(54) Head Light Detailer

(75) Inventor: Charles Maurice Young, Wake Forest, NC (US)

Correspondence Address: CHARLES M. YOUNG, 5000 DEER LAKE TRAIL, WAKE FOREST, NC, 27587, US

(73) Assignee: Charles Maurice Young, Wake Forest, NC (US)

(21) Appl. No.: 11/306,006

(22) Filed: Dec. 14, 2005

(51) Int. Cl. G02B 15/00

(52) U.S. Cl. 359/642

(57) ABSTRACT

The Headlight Detailer (HLD) is a three part process utilizing specific compounds and procedure for the purpose of detailing automobile headlights and restoring the functionality of the headlight lens. The first part of the process consists of using readily available glass cleaner applied to the headlight lens for initial cleaning. The second step in the process is applying an ammonia and silicone based solution for the purposes of enhanced cleaning and surface preparation. The third and final step in the process includes the application of a wax sealer containing a solution for regenerating the hardened acrylic resin lens surface coating and UV protection.

The Headlight Detailer (HLD) is a three part process utilizing specific compounds and procedure for the purpose of detailing automobile headlights.

Both the aesthetics and function of automobile headlight lens are degraded when a haze appears on the surface of the headlight lens. The degradation process begins with the lens being pitted by stones, sand, dirt, bugs and other hard objects at highway speeds. Simultaneously, organic and inorganic complexes such as bugs, dirt, grime, tar, oils, smog and other minute particles are rammed into the pitted surface. The pitted surface becomes microscopically filled with the opaque complexes and cause a haze to appear on the surface of the lens. The complexes yellow over time with exposure to UV rays. Severe cases of headlight lens degradation have caused automobiles to fail state mandated safety inspection. The lens becomes less able to transfer light through the lens material that has become increasingly opaque.

What is claimed is:

1. The use of HLD will remove discoloration and haze that ruins the appearance and function of automobile headlight lens. HLD will restore the lens surfaces, and reconstitute the hardened acrylic resin surface coating. The resulting finish restores the headlight lens to like new, or in worst cases, newer looking and functional condition.

2. Headlight lens in any condition can benefit for the HLD process. Headlight lens that appear in no need of service will show an immediate improvement in chrome reflector appearance after applying the HLD process. Increasing the visible reflectivity of the chrome reflector contained within the light fixture increases light projection. (More of the chrome is visible after the process). HLD is applicable in worst case situations by removing the minute dirt, oils, and smog that cloud the lens surface.
